(19) United States
(12) Patent Application Publication
(10) Pub. No.: US 2026/0370705 A1
(43) Pub. Date: Nov. 19, 2026

(54) METHOD, APPARATUS, DEVICE, MEDIUM, AND PROGRAM PRODUCT FOR DATA PROCESSING AND PROTOCOL CONVERSION

(71) Applicant: Beijing Zitiao Network Technology Co., Ltd., Beijing (CN)

(72) Inventors: Tianyi Liu, Beijing (CN); Liang Zhang, Beijing (CN); Ye-Kui Wang, Los Angeles, CA (US)

(21) Appl. No.: 19/735,428

(22) Filed: Jul. 8, 2026

Related U.S. Application Data
(63) Continuation of application No. PCT/CN2025/081218, filed on Mar. 7, 2025.

(51) Int. Cl. H04L 65/75; H04L 65/65; H04L 67/02

(52) U.S. Cl. CPC H04L 65/75; H04L 65/65; H04L 67/02

(57) ABSTRACT

A method, an apparatus, a device, a medium, and a program product for data processing and protocol conversion are provided. In an example data processing method, original data for a media stream is received, and the original data is segmented into a plurality of data segments. Further, at least one segmentation position identification for the plurality of data segments is added to the original data to obtain target data for the media stream. In an example protocol conversion method, target data for a media stream is received. The target data conforms to a first data protocol and includes at least one segmentation position identification for a plurality of data segments in the target data. Further, a plurality of segment files corresponding to the plurality of data segments are generated based on the target data and the at least one segmentation position identification.

### CROSS REFERENCE TO RELATED APPLICATIONS

The present application is a continuation of International Application No. PCT/CN2025/081218, filed on Mar. 7, 2025, which claims priority to Chinese Patent Application No. 202410029489.9, filed on Jan. 8, 2024 and entitled “DATA PROCESSING METHOD, PROTOCOL CONVERSION METHOD, APPARATUS, DEVICE, AND STORAGE MEDIUM”. The entire contents of these applications are hereby incorporated by reference in their entireties.

### FIELD

Embodiments of the present disclosure generally relate to the field of computer technologies, and in particular, to a method, an apparatus, a device, a medium, and a program product for data processing, and a method, an apparatus, a device, a medium, and a program product for protocol conversion.

### BACKGROUND

In recent years, with the continuous popularization of basic communications such as 4G/5G, the live streaming industry has developed vigorously in China and across the world. At present, in the technical system of Internet live streaming, a production end or a push end of live streaming content generally pushes a data flow to a cloud server based on the Hypertext Transfer Protocol (HTTP) or the Real Time Messaging Protocol (RTMP). A pull end of the live streaming content generally pulls the stream using a protocol such as Dynamic Adaptive Streaming over HTTP (DASH), HTTP-Flash Video (FLV), HTTP Live Streaming (HLS), or RTMP.

A segment-based streaming protocol (such as the DASH protocol, the HLS protocol, and so on) uses a method of segmenting a media stream into a plurality of media segments for transmission. This allows efficient and flexible transmission of audio and video content over the Internet, providing users with a high-quality viewing experience under different device and network conditions. In the case of using the segment-based streaming protocol to pull the stream, since the push stream uses the HTTP-FLV or RTMP protocol, protocol conversion is involved. However, during the protocol conversion, data files generated by performing protocol conversion on the same media stream on different protocol conversion devices may be inconsistent, which leads to a playback error of a player on the user side. Therefore, how to ensure the consistency of data files (i.e., distributed consistency of segmentation) generated by performing protocol conversion on the same media stream on different protocol conversion devices has become an urgent problem to be solved.

### SUMMARY

In a first aspect of the present disclosure, a method for data processing is provided. In the method, original data for a media stream is received, and the original data is segmented into a plurality of data segments. Further, at least one segmentation position identification for the plurality of data segments is added to the original data to obtain target data for the media stream. The target data conforms to a same first data protocol as the original data.

In a second aspect of the present disclosure, a method for protocol conversion is provided. In the method, target data for a media stream is received. The target data conforms to a first data protocol and includes at least one segmentation position identification for a plurality of data segments in the target data. Further, a plurality of segment files corresponding to the plurality of data segments are generated based on the target data and the at least one segmentation position identification. The plurality of segment files conform to a second data protocol different from the first data protocol.

In a third aspect of the present disclosure, an apparatus for data processing is provided. The apparatus includes a receiving module, a segmentation module, and an addition module. The receiving module is configured to receive original data for a media stream. The segmentation module is configured to segment the original data into a plurality of data segments. The addition module is configured to add at least one segmentation position identification for the plurality of data segments to the original data to obtain target data for the media stream. The target data conforms to a same first data protocol as the original data.

In a fourth aspect of the present disclosure, an apparatus for protocol conversion is provided. The apparatus includes a receiving module and a generation module. The receiving module is configured to receive target data for a media stream. The target data conforms to a first data protocol and includes at least one segmentation position identification for a plurality of data segments in the target data. The generation module is configured to: generate, based on the target data and the at least one segmentation position identification, a plurality of segment files corresponding to the plurality of data segments, the plurality of segment files conforming to a second data protocol different from the first data protocol.

In a fifth aspect of the present disclosure, an electronic device is provided. The electronic device includes at least one processor and at least one memory. The at least one memory is coupled to the at least one processor and stores instructions executable by the at least one processor, the instructions, when executed by the at least one processor, causing the electronic device to perform the method of the first aspect or the method of the second aspect.

In a sixth aspect of the present disclosure, a computer-readable storage medium is provided. The computer-readable storage medium stores thereon instructions that, when executed by a processor, cause the processor to implement the method of the first aspect or the method of the second aspect.

In a seventh aspect of the present disclosure, a computer program product is provided. The computer program product is tangibly stored in a computer storage medium and includes computer-executable instructions that, when executed by a device, cause the device to perform the method of the first aspect or the method of the second aspect.

It should be appreciated that content described in the Summary section of the present disclosure is neither intended to identify key or essential features of embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages, and aspects of embodiments of the present disclosure will become more apparent in the following, in conjunction with the drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a flowchart of a method for data processing according to some embodiments of the present disclosure;

FIG. 3 illustrates a schematic diagram of data processing according to some embodiments of the present disclosure;

FIG. 4 illustrates a flowchart of a method for protocol conversion according to some embodiments of the present disclosure;

FIG. 5 illustrates a schematic diagram of segmentation processing for target media stream data according to some embodiments of the present disclosure;

FIG. 6 illustrates a schematic diagram of an example process of media stream distribution according to some embodiments of the present disclosure;

FIG. 7 illustrates a schematic diagram of another example process of media stream distribution according to some embodiments of the present disclosure;

FIG. 8 illustrates a block diagram of an example apparatus for data processing according to some embodiments of the present disclosure;

FIG. 9 illustrates a block diagram of an example apparatus for protocol conversion according to some embodiments of the present disclosure; and

FIG. 10 illustrates a block diagram of a device in which one or more embodiments of the present disclosure may be implemented.

### DETAILED DESCRIPTION OF EMBODIMENTS

Embodiments of the present disclosure will be described in more detail below with reference to the drawings. Although certain embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for illustrative purposes and are not intended to limit the protection scope of the present disclosure.

It should be understood that steps described in method implementations of the present disclosure may be performed in different orders, and/or performed in parallel. In addition, the method implementations may include additional steps and/or omit performing the illustrated steps. The scope of the present disclosure is not limited in this regard.

In the description of the embodiments of the present disclosure, the term “include/comprise” and similar terms should be understood as open-ended inclusions, that is, “include/comprise but not limited to”. The term “based on” should be understood as “at least partially based on”. The term “one embodiment” or “the embodiment” should be understood as “at least one embodiment”. The term “some embodiments” should be understood as “at least some embodiments”. Other explicit and implicit definitions may also be included below. As used herein, the term “model” may represent an association between various data. For example, the above association may be obtained based on various technical solutions currently known and/or to be developed in the future.

As used herein, the term “responsive to” represents a state in which a corresponding event occurs or a condition is satisfied. It will be understood that there is not necessarily a strong correlation between the execution timing of a subsequent action performed responsive to the event or condition and the time at which the event occurs or the condition is satisfied. For example, in some cases, the subsequent action may be performed immediately when the event occurs or the condition is satisfied; in other cases, the subsequent action may be performed after a period of time has elapsed since the event occurred or the condition was satisfied.

It may be understood that data involved in the technical solution (including but not limited to the data itself, acquisition or use of the data) should comply with requirements of corresponding laws, regulations, and related provisions.

It may be understood that before using the technical solution disclosed in the embodiments of the present disclosure, the user should be informed of the type, range of use, use scenarios, etc., of personal information involved in the present disclosure in an appropriate manner in accordance with relevant laws and regulations, and the authorization of the user should be obtained.

For example, responsive to receiving an active request from a user, prompt information is sent to the user to clearly prompt the user that the requested operation will require access to and use of the user's personal information. In this way, the user may independently choose, based on the prompt information, whether to provide the personal information to software or hardware, such as an electronic device, an application, a server, or a storage medium, that performs operations of the technical solution of the present disclosure.

As an optional but non-restrictive embodiment, responsive to receiving the active request from the user, the manner of sending the prompt information to the user, for example, may be in a manner of a pop-up window, and the prompt information may be presented in the pop-up window in text. In addition, the pop-up window may also carry a selection control for the user to select “agree” or “disagree” to provide the personal information to the electronic device.

It may be understood that the above process of notifying and obtaining user authorization is only illustrative and does not constitute a limitation to the embodiments of the present disclosure, and other manners that meet relevant laws and regulations may also be applied to the embodiments of the present disclosure.

As briefly mentioned above, in a live streaming scenario, when different protocols are used in a push process and a pull process, for example, when the FLV or RTMP protocol is used in the push process and the DASH or HLS protocol is used in the pull process, the conversion from the FLV or RTMP protocol to the DASH or HLS protocol is involved. This protocol conversion is generally completed by a protocol conversion device. The protocol conversion device usually segments the media stream data according to certain requirements and converts it into Transport Stream (TS) small files or Fragmented MP4 (FMP4) small files one by one, and at the same time, timely updates a manifest, such as an m3u8 file or a Media Presentation Description (MPD).

Segmentation results obtained when protocol conversion is performed on the same media stream on different protocol conversion devices may be inconsistent, and inconsistent segmentation may lead to unexpected playback errors of a player. In existing solutions, a single protocol conversion device is often used, that is, protocol conversion for the same media stream is always completed on one protocol conversion device. This results in an inability to switch protocol conversion devices, thus the flexibility and availability of the protocol conversion solution are poor.

To this end, embodiments of the present disclosure propose a solution to achieve distributed consistency of segmentation by adding a segmentation position identification into original media stream data. Specifically, some embodiments of the present disclosure propose a solution for data processing, which includes: receiving original data for a media stream; segmenting the original data into a plurality of data segments; and adding at least one segmentation position identification for the plurality of data segments to the original data to obtain target data for the media stream, the target data conforming to a same first data protocol as the original data. In addition, some other embodiments of the present disclosure further propose a solution for protocol conversion, which includes: receiving target data for a media stream, the target data conforming to a first data protocol and including at least one segmentation position identification for a plurality of data segments in the target data; and generating a plurality of segment files corresponding to the plurality of data segments based on the target data and the at least one segmentation position identification, the plurality of segment files conforming to a second data protocol different from the first data protocol.

It will be understood more clearly through the description below that, according to the embodiments of the present disclosure, a segmentation position identification is added to original media stream data to obtain target media stream data, and the target media stream data is transmitted transparently in a transmission system for the media stream. At a device that performs protocol conversion, the protocol conversion is performed on the media stream data based on the segmentation position identification. In this way, it may be ensured that protocol conversion results of the same media stream data by different protocol conversion devices are consistent, thereby achieving the distributed consistency of segmentation. Therefore, this makes it possible to support protocol conversion for the same media stream on different protocol conversion devices, and enables a player not to have a playback error due to inconsistent segmentation results when the protocol conversion devices are switched, so that the efficiency and fault-tolerance of the protocol conversion may be improved, and the playback effect of the media stream data may be improved.

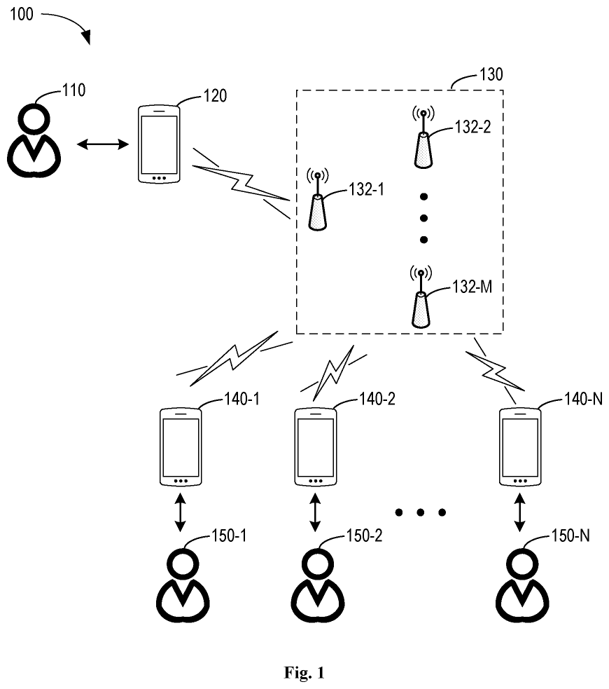

Various example implementations of the solution will be described in detail below with reference to the drawings. Referring first to FIG. 1, it illustrates a schematic diagram of an example environment 100 in which embodiments of the present disclosure may be implemented. The example environment 100 is shown for a live streaming scenario, where the example environment 100 may generally include a streamer 110, a push device 120, a stream transmission system 130, pull devices 140-1, 140-2, . . . , 140-N, and audiences 150-1, 150-2, . . . , 150-N, where N is any suitable positive integer, such as 1, 5, 70, 500, and so on. The push device 120 is communicatively coupled to the stream transmission system 130, and the stream transmission system 130 is communicatively coupled to the pull device 140. The stream transmission system 130 may be implemented through a Content Delivery Network (CDN) or other networks. In the example shown in FIG. 1, the stream transmission system 130 may include transmission devices 132-1, 132-2, . . . , 132-M, where M is any suitable positive integer, such as 20, 100, 500, and so on. For the purpose of convenient description, the transmission devices 132-1, 132-2, . . . , 132-M may also be individually or collectively referred to as the transmission device 132, the pull devices 140-1, 140-2, . . . , 140-N may also be individually or collectively referred to as the pull device 140, and the audiences 150-1, 150-2, . . . , 150-N may also be individually or collectively referred to as the audience 150.

As shown in FIG. 1, the streamer 110, for example, may initiate live streaming by operating the push device 120, and then the push device 120 may upload local audio and video data to the stream transmission system 130 through a network according to a specific protocol (for example, the RTMP protocol or the FLV protocol, and so on). The audience 150, for example, may initiate viewing of the live streaming content of the streamer 110 by operating the pull device 140, and then the pull device 140 may request a media stream of the streamer 110 from the stream transmission system 130, acquire the audio and video data from the stream transmission system 130, and decode and play it for the audience 150 to watch and listen to.

In FIG. 1, the push device 120 and the pull device 140 are shown as mobile phones, but the push device 120 and/or the pull device 140 may also be any type of mobile terminal or portable terminal, including a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the foregoing, including accessories and peripherals of these devices or any combination thereof. In some embodiments, the push device 120 and/or the pull device 140 may also support any type of user-specific interface (such as a “wearable” circuit, etc.).

It should be understood that the structure and function of the environment 100 are described only for illustrative purposes, without suggesting any limitation to the scope of the present disclosure. For example, the method according to the embodiments of the present disclosure may also be applied to any other suitable scenario other than the live streaming scenario, such as an on-demand scenario, and so on.

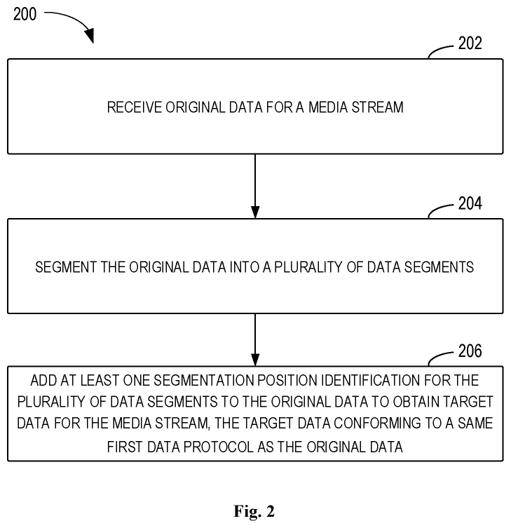

FIG. 2 illustrates a flowchart of a method 200 for data processing according to some embodiments of the present disclosure. In some embodiments, the method 200 may be performed at the push device 120 or the transmission device 132 shown in FIG. 1. It should be understood that the method 200 may also include additional blocks not shown and/or omit a certain (or some) of the blocks shown, and the scope of the present disclosure is not limited in this regard.

At block 202, original data for a media stream is received. The original data of the media stream may conform to a first data protocol, and is media stream data to be subjected to protocol conversion, for example, media stream data generated or uploaded from a streamer side during live streaming. In the context of the present disclosure, the original data of the media stream may also be referred to as original media stream data. The original media stream data may include video data and/or audio data. The data protocol may include a data transmission protocol, a data encapsulation protocol, and/or other related protocols. For example, the first data protocol may be a data transmission protocol used for the original media stream data, that is, an original data transmission protocol to be subjected to protocol conversion. In some embodiments, the first data protocol may include an FLV protocol or an RTMP protocol, for example, the original media stream data may be transmitted based on the FLV protocol or the RTMP protocol. It should be understood that the first data protocol may also be any other suitable data protocol, and the scope of the present disclosure is not limited in this regard. In the example shown in FIG. 1, the transmission device 132-1 may receive the original media stream data uploaded by the push device 120 based on the first data protocol. In this case, the transmission device 132-1 may also be referred to as a push node.

At block 204, the original data is segmented into a plurality of data segments. In some embodiments, the original data may be segmented based on a preset data length of a second data protocol. The second data protocol is different from the first data protocol, and may be a data transmission protocol to which the original media stream data needs to be converted, that is, a target data transmission protocol for the protocol conversion. For example, the second data protocol may be a segment-based streaming protocol, such as a DASH protocol, an HLS protocol, and so on. For example, the original media stream data may be converted from the first data protocol to the DASH protocol or the HLS protocol.

In some embodiments, the preset data length may be a predetermined duration of a data segment, that is, a segment length (that is, segment duration) when converted to the second data protocol. For example, an expected segment length, a minimum segment length, etc., when the original media stream data is converted from the first data protocol to the second data protocol may be set in advance as needed. The original data may be segmented into a plurality of data segments according to the preset data length. For example, segmentation positions in the original media stream data may be sequentially determined according to the preset data length of the second data protocol, and a data length between two adjacent segmentation positions may be greater than or equal to the preset data length. For example, the data length between two adjacent segmentation positions is not less than the preset data length, and a difference from the preset data length is within a specified range. For example, the data length is as close to the preset data length as possible on the premise that requirements are met.

In an example embodiment, the specific position of the segmentation position in the original media stream data may not be limited. For example, the segmentation position in the original media stream data may be determined directly based on the preset data length without considering a relative position relationship between the segmentation position and a frame included in the original media stream data. For example, one segmentation position may be determined every preset data length in the original media stream data. In this case, the data length between two adjacent segmentation positions in the original media stream data may be equal to the preset data length.

In another example embodiment, the specific position of the segmentation position in the original media stream data may be limited. For example, a relative position relationship between the segmentation position and a position of a random access point (for example, an I frame) in the media stream may be considered. In other words, the relative position relationship between the segmentation position and at least some frames included in the original media stream data may be considered. For example, the segmentation position may be defined as conforming to a preset position condition. In this case, an original segmentation position of the original media stream data may be determined according to the preset data length of the second data protocol. Here, the original segmentation position may be understood as a candidate segmentation position preliminarily determined based on the preset data length for the second data protocol. The original segmentation position may or may not conform to the preset position condition. If the determined original segmentation position conforms to the preset position condition, the original segmentation position is used as an actual segmentation position of the original media stream data. If the determined original segmentation position does not conform to the preset position condition, the position of the original segmentation position is adjusted according to the preset position condition, and the adjusted original segmentation position is used as the actual segmentation position of the original media stream data.

For example, the original segmentation position of the original media stream data may be determined according to the preset data length for the second data protocol. For example, the current original segmentation position is determined at a distance of the preset data length from a previous segmentation position in the original media stream data. Then it is determined whether the original segmentation position conforms to the preset position condition. If it conforms to the preset position condition, the original segmentation position may be determined as an actual segmentation position for the original media stream data. If it does not conform to the preset position condition, the position of the original segmentation position may be adjusted according to the preset position condition, and the original segmentation position may be adjusted to a segmentation position that conforms to the preset position condition. In this way, when there is a preset position condition, the actual segmentation position may be a segmentation position that conforms to the preset position condition, for example, a segmentation position determined based on the preset data length of the second data protocol and the preset position condition.

In some embodiments, the preset position condition may be a condition for limiting the relative position relationship between the segmentation position and at least some frames in the original media stream data. For example, the at least some frames may include a video key frame (I frame), a video forward prediction frame (P frame), an audio frame (A frame), and so on. The preset position condition may be set as needed. As an example, the preset position condition may be that a frame located after the segmentation position and adjacent to the segmentation position should be a video key frame. For example, when adjusting the position of the original segmentation position according to the preset position condition, the original segmentation position may be adjusted to a position before and adjacent to a certain video key frame, for example, the original segmentation position may be adjusted backward to a position before and adjacent to the certain video key frame. The considered video key frame may also be set as needed. For example, the video key frame may be a video key frame closest to the original segmentation position in the original media stream data, so that a data length between two adjacent segmentation positions is as close as possible to the preset data length of the second data protocol on the premise that the preset position condition is met, thereby improving the effect of subsequent protocol conversion. In this case, the original segmentation position may be adjusted backward to before the video key frame closest to the original segmentation position, that is, the original segmentation position may be adjusted backward to a position before and adjacent to the video key frame closest to the original segmentation position. In this way, it may be ensured that a first frame of a segment file (such as a video file) obtained through protocol conversion based on the segmentation position is a video key frame, thereby implementing random access and independent start-up of playback, and further improving the playback effect of the data file obtained through protocol conversion.

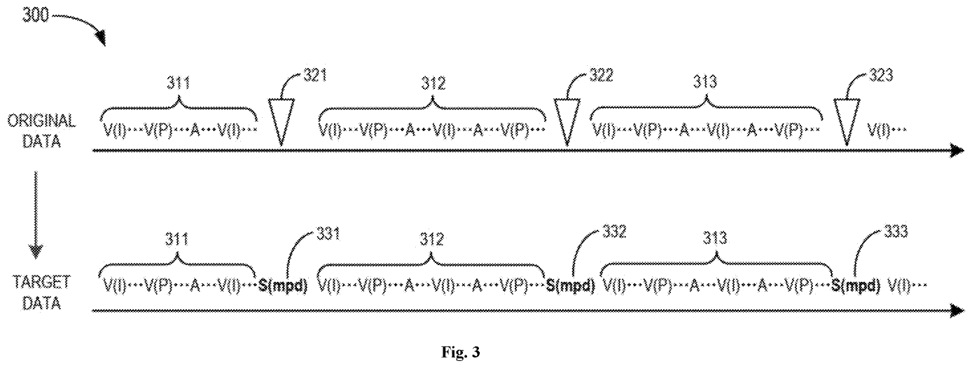

FIG. 3 illustrates a schematic diagram 300 of data processing according to some embodiments of the present disclosure. As shown in the upper half of FIG. 3, the original data is segmented at a segmentation position 321, a segmentation position 322, and a segmentation position 323, thereby obtaining a data segment 311, a data segment 312, and a data segment 313. In FIG. 3, V(I) represents data of a video I frame, V(P) represents data of a video P frame, and A represents data of an audio frame. It may be seen that in the example of FIG. 3, the segmentation position 321, the segmentation position 322, and the segmentation position 323 are all before and adjacent to an I frame, thereby ensuring random access and independent start-up of playback.

It should be noted that at block 204, the original data is only segmented into a plurality of data segments, and a plurality of segment files that conform to the second data protocol are not generated. In other words, what is performed at block 204 is a simulated segmentation process (that is, a simulated protocol conversion process) for the purpose of determining the segmentation position, and no repackaging operation is performed. In other words, no segment file for the second data protocol is generated during the simulated segmentation process. It should be understood that the original data may also be segmented into a plurality of data segments in any other suitable manner, for example, by considering other factors that affect the segmentation position. The scope of the present disclosure is not limited in this regard.

Returning to FIG. 2, at block 206, at least one segmentation position identification for the plurality of data segments is added to the original data to obtain target data for the media stream. The target data conforms to a same first data protocol as the original data. Each of the at least one segmentation position identification may correspond to two adjacent data segments of the plurality of data segments, and indicate a position of a boundary between the two adjacent data segments. For example, each of the at least one segmentation position identification may be inserted between the two corresponding adjacent data segments.

In some embodiments, the segmentation position identification may be added to the original data based on the segmentation position determined by the segmentation operation at block 204 to obtain the media stream data added with the segmentation position identification, that is, the target data of the media stream. In the context of the present disclosure, the target data of the media stream may also be referred to as target media stream data. Referring to FIG. 3, segmentation position identifications 331, 332, and 333 are added to the target data as compared with the original data. The segmentation position identification 331 may correspond to the data segment 311 and the data segment 312, and is inserted between the data segment 311 and the data segment 312 to indicate a boundary between the two data segments. Similarly, the segmentation position identification 332 may correspond to the data segment 312 and the data segment 313, and is inserted between the data segment 312 and the data segment 313 to indicate a boundary between the two data segments. In this way, the segmentation position may be efficiently indicated, thereby improving the efficiency of subsequent protocol conversion. It should be understood that the segmentation position identification may also indicate the position of the boundary between two adjacent data segments in any other suitable manner, for example, the segmentation position identification may record the segmentation position based on a Presentation Time Stamp (PTS) or a Decoding Time Stamp (DTS) of a frame adjacent to the segmentation position. The scope of the present disclosure is not limited in this regard.

In some embodiments, the segmentation position identification may include description information of a plurality of media segments of the media stream that correspond to the plurality of data segments, the description information being used for the second data protocol. In the context of the present disclosure, a code stream of a corresponding media segment may be obtained from one data segment through demultiplexing. In some embodiments, the description information may include identification information, a time stamp start position, a segment duration, a Uniform Resource Locator (URL), etc., of the latest one or more consecutive video files and audio files. For example, the description information may be implemented in a form of a manifest. For example, in a case where the second data protocol includes the DASH protocol, the description information may include an MPD file for the DASH protocol of the plurality of media segments. In the example shown in FIG. 3, the segmentation position identifications 331, 332, and 333 are Script frames containing MPD information. Alternatively or additionally, in a case where the second data protocol includes the HLS protocol, the description information may include index information for the HLS protocol of the plurality of media segments, such as an m3u8 file. For the purpose of easy understanding, a non-limiting example of the m3u8 file is given below, where text after “//” is an explanation for corresponding content added for the purpose of easy understanding.

#EXTM3U // Indicates that the file is in the m3u8 format
#EXT-X-VERSION:3 // Defines the version number of the m3u8 file
#EXT-X-TARGETDURATION:3 // Specifies the maximum duration of each media segment in seconds
#EXT-X-MEDIA-SEQUENCE:101 // Specifies the sequence number of the first media segment
#EXTINF:3.000, // Specifies the duration of the media segment
Segment101.ts // Identifies the media segment with the sequence number of 101
#EXTINF:3.000, // Specifies the duration of the media segment
Segment102.ts // Identifies the media segment with the sequence number of 102
#EXTINF:3.000, // Specifies the duration of the media segment
Segment103.ts // Identifies the media segment with the sequence number of 103

It should be understood that the information mentioned in the above m3u8 file is only illustrative and non-limiting. Additional information not listed may also be included and/or a certain (or some) of the information listed may be omitted, and the scope of the present disclosure is not limited in this regard.

In some embodiments, the segmentation position identification may further include an identification for a method. For example, the identification for the method may be implemented in a form of a method name. The method name of the method according to the embodiments of the present disclosure may be, for example, onSegmentSync or any other suitable string. It should be understood that the segmentation position identification may further include any other suitable information, and the scope of the present disclosure is not limited in this regard.

In some embodiments, information included in the segmentation position identification may be encapsulated based on a target data structure. The target data structure may depend on the first data protocol. For example, in a case where the first data protocol includes the FLV protocol, the target data structure includes a script data (SCRIPTDATA) structure, also known as a Script frame structure. The script data structure may include a script tag body (ScriptTagBody) encoded in an Action Message Format (AMF). The script tag body is used to encapsulate a method call, which includes: an item containing a method name and a corresponding set of arguments. The set of arguments may have a type of ECMA Array, for example. The array may include attributes for achieving distributed consistency of segmentation. The availability of these attributes may depend on the software used to create the FLV stream, the second data protocol, and whether multitrack streaming via Enhanced RTMP (E-RTMP) is being used, and so on. Table 1 below shows some example attributes.

TABLE 1
Typical attributes available in the onSegmentSync parameter object

| Attribute | Type | Remarks |
|---|---|---|
| mpd | String | MPD file corresponding to the current media |
| | | data segment |
| trackidM3U8Map | Object | The trackidM3U8Map object is configured to |
| | | store a mapping from a track index (also |
| | | denoted as trackId) to an HLS m3u8 playlist |
| | | for a variant stream. |

For the purpose of easy understanding, a non-limiting example of the attribute trackidM3U8Map is given below.

trackidM3U8Map = {

| | |
|---|---|
| 1: “#EXTM3U\n#EXT-X-VERSION:4\n#EXT-X-TARGETDURATION:10\n | #EXT-X-MEDIA- |

SEQUENCE:0\n\n#EXTINF:10,\nvideo-hd-segment0.mp4\n#EXTINF:10,\nvideo-hd-
segment1.mp4\n#EXTINF:10,\nvideo-hd-segment2.mp4”,

| | |
|---|---|
| 2: “#EXTM3U\n#EXT-X-VERSION:4\n#EXT-X-TARGETDURATION:10\n | #EXT-X-MEDIA- |

SEQUENCE:0\n\n#EXTINF:10,\nvideo-uhd-segment0.mp4\n#EXTINF:10,\nvideo-uhd-
segment1.mp4\n#EXTINF:10,\nvideo-uhd-segment2.mp4”,

| | |
|---|---|
| 3: “#EXTM3U\n#EXT-X-VERSION:4\n#EXT-X-TARGETDURATION:10\n | #EXT-X-MEDIA- |

SEQUENCE:0\n\n#EXTINF:10,\naudio-segment0.mp4\n#EXTINF:10,\naudio-
segment1.mp4\n#EXTINF:10,\naudio-segment2.mp4”
}

It may be seen that a track with trackId=1 corresponds to an m3u8 playlist for high-definition video (represented by video-hd), a track with trackId=2 corresponds to an m3u8 playlist for ultra-high-definition video (represented by video-uhd), and a track with trackId=3 corresponds to an m3u8 playlist for audio (represented by audio). In this way, the m3u8 playlist corresponding to each track of the media stream may be determined based on the above mapping relationship according to a track index of the track. It should be noted that in the above example, “/n” represents a line break. It should be understood that this example for the attribute trackidM3U8Map is only shown for the purpose of illustration, and the scope of the present disclosure is not limited in this regard.

It should be understood that the attributes listed in Table 1 are only illustrative and non-limiting. Additional attributes not listed may also be included and/or a certain (or some) of the attributes listed may be omitted, and the scope of the present disclosure is not limited in this regard. For example, in a case where multitrack streaming is not enabled, the above trackidM3U8Map attribute may be omitted, and the attribute M3U8 may be additionally included. The attribute M3U8 is of a string type, and carries an m3u8 playlist for the HLS protocol corresponding to the current media data segment.

In some embodiments, the target media stream data may further include one or more example attributes shown in the following Table 2.

TABLE 2
Typical attributes available in the onSegmentSync
or onMetaData parameter object

| Attribute | Type | Remarks |
|---|---|---|
| hlsMultivariantPlaylist | String | HLS multivariant playlist |
| | | corresponding to the RTMP |
| | | stream |
| trackRepresentationMap | Object | The trackRepresentationMap object is |
| | | configured to represent a mapping |
| | | between a trackId and a DASH |
| | | representation, and needs to be used |
| | | in combination with an end-to-end |
| | | synchronization mechanism. |
| trackHlsStreamMap | Object | The trackHlsStreamMap object is |
| | | configured to represent a mapping |
| | | between a trackId and an HLS |
| | | stream, and needs to be used in |
| | | combination with an end-to-end |
| | | synchronization mechanism. |

Here, the end-to-end synchronization mechanism means that the attribute is transmitted transparently in the stream transmission system 130 with the media stream data.

In some embodiments, the attribute trackRepresentationMap may adopt a Key-Value Structure, where a key may be a trackId, which acts as a unique identifier of a specific audio track or video track; a value may be a DASH representation ID corresponding to the track. It should be understood that the value may also be an International Organization for Standardization Base Media File Format (ISOBMFF) file track ID, and so on. For the purpose of easy understanding, a non-limiting example of the attribute trackRepresentationMap is given below.

```
trackRepresentationMap = {
  0: video_1080p,
  1: video_720p,
  2: audio_eng_128k,
  3: audio_eng_256k
}
```

In the above example, 0, 1, 2, and 3 are keys, and “video_1080p”, “video_720p”, “audio_eng_128k”, and “audio_eng_256k” are values. It may be seen that a track with trackId=0 corresponds to a DASH representation ID “video_1080p”, which represents a video with a resolution of 1080p; a track with trackId=1 corresponds to a DASH representation ID “video_720p”, which represents a video with a resolution of 720p; a track with trackId=2 corresponds to a DASH representation ID “audio_eng_128k”, which represents English audio with a bit rate of 128 kbps; and a track with trackId=3 corresponds to a DASH representation ID “audio_eng_256k”, which represents English audio with a bit rate of 256 kbps. In this way, the DASH representation ID of each track of the media stream may be determined based on the above mapping relationship according to a track index of the track. It should be understood that this example for the attribute trackRepresentationMap is only shown for the purpose of illustration, and the scope of the present disclosure is not limited in this regard.

In some embodiments, the attribute trackHlsStreamMap may adopt a Key-Value Structure, where a key may be a trackId, which acts as a unique identifier of a specific audio track or video track; a value may be an HLS stream m3u8 file name corresponding to the track. For the purpose of easy understanding, a non-limiting example of the attribute trackHlsStreamMap is given below.

```
trackHlsStreamMap = {
  0: video_1080p.m3u8,
  1: video_720p.m3u8,
  2: audio_eng.m3u8,
  3: audio_eng_alt.m3u8
}
```

In the above example, 0, 1, 2, and 3 are keys, and “video_1080p.m3u8”, “video_720p.m3u8”, “audio_eng.m3u8”, and “audio_eng_alt.m3u8” are values. It may be seen that a track with trackId=0 corresponds to an m3u8 file name “video_1080p.m3u8” for a video stream with a resolution of 1080p, a track with trackId=1 corresponds to an m3u8 file name “video_720p.m3u8” for a video stream with a resolution of 720p, a track with trackId=2 corresponds to an m3u8 file name “audio_eng.m3u8” for an English audio stream, and a track with trackId=3 corresponds to an m3u8 file name “audio_eng_alt.m3u8” for another English audio stream. In this way, the HLS stream corresponding to each track of the media stream may be determined based on the above mapping relationship according to a track index of the track. It should be understood that this example for the attribute trackHlsStreamMap is only shown for the purpose of illustration, and the scope of the present disclosure is not limited in this regard.

In some embodiments, one or more of the above attributes hlsMultivariantPlaylist, trackRepresentationMap, and trackHlsStreamMap may be included in the segmentation position identification, for example, encapsulated in a Script frame. In other words, each segmentation position identification carries one or more of these attributes. Alternatively, since information carried by the above attributes hlsMultivariantPlaylist, trackRepresentationMap, and trackHlsStreamMap is relatively fixed, one or more of these attributes may also be transmitted once in a session, that is, independently of the segmentation position identification. In this case, one or more of these attributes may be included in metadata onMetaData. The metadata onMetaData is mainly used to describe relevant parameters of an audio and video encoding format, and may adopt the script data format described above. Transmitting the above attributes hlsMultivariantPlaylist, trackRepresentationMap, and/or trackHlsStreamMap in the metadata onMetaData may save network bandwidth.

It should be understood that the names of the attributes mentioned above are only illustrative and non-limiting, and the names of these attributes may also be any other suitable strings. The scope of the present disclosure is not limited in this regard.

In some embodiments, each segmentation position identification may carry one or more manifests corresponding to a current media data segment associated with a script data segment. In an example embodiment, the current media data segment associated with the script data segment may consist of all media data located after the script data segment until a next script data segment or an end of the media stream, whichever comes first. In another example embodiment, the current media data segment associated with the script data segment may consist of all media data located before the script data segment until a previous script data segment or a start of the media stream, whichever comes last.

In addition, in a case where the first data protocol includes the RTMP protocol, the target data structure may correspond to a metadata message or a data message. For example, the target data structure may also include an item containing a method name and a corresponding set of arguments. The set of arguments may have a type of ECMA Array, for example, and the array may include attributes for achieving distributed consistency of segmentation. This is similar to the attributes described above with reference to the script tag body, and details are not repeated in the present disclosure. In this way, a predetermined data structure may be used to better encapsulate the arguments and information for the method according to the embodiments of the present disclosure, so that it may be transmitted through the first data protocol.

In some embodiments, the description information includes description information corresponding to each track of at least one track of the media stream, and the target data includes a mapping relationship between each track and the corresponding description information. For example, in a case where the second data protocol includes an HLS protocol, the segmentation position identification includes a first indication (for example, the above attribute trackidM3U8Map) for indicating a mapping relationship between a track index and index information for the HLS protocol of the plurality of media segments, and the target data includes a second indication (for example, the above attribute hlsMultivariantPlaylist) for indicating an HLS multivariant playlist, and a third indication (for example, the above attribute trackHlsStreamMap) for indicating a mapping between a track index and an HLS variant stream. In a case where the second data protocol includes a DASH protocol, the segmentation position identification includes an MPD for the DASH protocol of the plurality of media segments (for example, the above attribute mpd), and the target data includes a fourth indication (for example, the above attribute trackRepresentationMap) for indicating a mapping between a track index and a DASH representation. In this way, the method according to the embodiments of the present disclosure may better support an application scenario of multitrack streaming, thereby expanding the availability and flexibility of the method. In an example embodiment, the second indication, the third indication, and/or the fourth indication may be included in the segmentation position identification. Alternatively, the second indication, the third indication, and/or the fourth indication may be included in other data parts (for example, the metadata onMetaData) of the target media stream data. It should be understood that the above first indication, second indication, third indication, and fourth indication may also be implemented in any other suitable manner, and the scope of the present disclosure is not limited in this regard. For example, the fourth indication may also be implemented as one or more flags, each flag indicating that one representation ID in the MPD corresponds to a single track index in the original RTMP/FLV multitrack stream.

In some embodiments, the segmentation position identification is unencrypted. In other words, even in the case where the original data itself is encrypted, the segmentation position identification may be unencrypted. In this way, consistent protocol conversion of the media stream data by different protocol conversion devices may be better achieved.

In some embodiments, the segmentation position identifications added at different segmentation positions may be the same in some aspects. For example, the segmentation position identifications added at different segmentation positions may be segmentation position identifications of a same type, for example, all data frames (for example, Script frames) or metadata messages. Alternatively or additionally, the segmentation position identifications added at different segmentation positions may be different in some aspects. For example, the segmentation position identifications added at different segmentation positions may contain different content, for example, the segmentation position identification added at a specific segmentation position may contain latest content corresponding to the segmentation position. The segmentation position identification may contain current description information for the second data protocol. In this case, the current description information for the second data protocol of one or more media segments may be acquired, the segmentation position identification containing the current description information may be generated, and the generated segmentation position identification may be added to a corresponding segmentation position.

The description information may be generated by performing simulated segmentation (that is, simulated protocol conversion) on the original media stream data. The simulated protocol conversion may be different from actual protocol conversion, for example, during the simulated protocol conversion, it is only necessary to determine the segmentation position and/or generate and update the description information, without finally generating the data file that conforms to the second data protocol. The current description information may be latest description information for the second data protocol of the one or more media segments when the segmentation position identification to be added for the specific segmentation position is generated. The latest description information may be, for example, a manifest corresponding to the second data protocol. In some embodiments, the segmentation position identifications are added one by one with the uploading of the original media stream data, and the description information is updated with the uploading of the original media stream data. In this case, the current description information contained in the segmentation position identifications added at different segmentation positions in the original media stream data may be different, so that the description information may be restored from the segmentation position identifications during subsequent protocol conversion.

For example, for a segmentation position to which a segmentation position identification is currently to be added, information of a manifest for the second data protocol may be acquired as the current description information, and the current description information may be written into the segmentation position identification, for example, in a form of a data frame or a data message. Further, the segmentation position identification may be added to the corresponding segmentation position. It should be understood that the description information and the segmentation position identification may also be obtained in any other suitable manner. The scope of the present disclosure is not limited in this regard.

It may be seen from the above description with reference to FIGS. 2 to 3 that in the method for data processing according to the embodiments of the present disclosure, by segmenting the original media stream data into a plurality of data segments and adding at least one segmentation position identification for the plurality of data segments to the original data, the target media stream data carrying at least segmentation position information may be acquired. In this way, it is possible to facilitate direct execution of the protocol conversion based on the segmentation position information carried in the target media stream data in a subsequent protocol conversion process, which may effectively ensure that results of the protocol conversion of the same media stream data by different protocol conversion devices remain consistent, thereby enabling the consistent protocol conversion of the media stream data by the different protocol conversion devices. Therefore, it may be ensured that in a case where the protocol conversion devices are switched, a player will not have a playback error due to inconsistent protocol conversion results, thereby effectively improving the consistency of the protocol conversion, and ensuring the playback effect of the media stream data.

In some embodiments, the method for data processing according to the embodiments of the present disclosure may be implemented at a first device in the stream transmission system 130 for the media stream. The first device may receive a request for the media stream from a second device. Further, the first device may determine, based on the request, whether the second device is also located in the stream transmission system 130. For example, the first device may determine whether the second device is located in the stream transmission system 130 based on a parameter or an attribute of the request. Alternatively, the request itself from the second device may carry information indicating whether the second device is located in the stream transmission system 130.

If it is determined that the second device is in the stream transmission system 130, the first device may send the target data for the media stream to the second device. In this way, the target media stream data carrying the segmentation position information may be transmitted transparently in the stream transmission system. If it is determined that the second device is outside the stream transmission system 130, the first device may send the original data for the media stream to the second device. In an example embodiment, the original data may be the original data received by the first device. In another example implementation, the first device may delete all added segmentation position identifications from the target media stream data to restore the original media stream data. In this way, it is possible to avoid errors when a device outside the stream transmission system parses or plays the target media stream data.

In some embodiments, in a case where the stream transmission system 130 is implemented through a content delivery network, the first device may be an origin station in the content delivery network. For example, the first device may be a first origin station in an upload link of the original media stream data. In an example embodiment, the second device may also be an origin station in the content delivery network. In another example embodiment, the second device may be an edge node in the content delivery network. Referring to FIG. 1, the pull device 140 may request the media stream data from the transmission device 132-M nearby. In this case, the second device may correspond to the transmission device 132-M, and may also be referred to as a pull node. In yet another example embodiment, the second device may be a device outside the content delivery network, such as the pull device 140 shown in FIG. 1.

In some other embodiments, the first device may be an edge node in the content delivery network. For example, the first device may be a first edge node (that is, a push node) in the upload link of the original media stream data. In an example embodiment, the second device may be an origin station in the content delivery network. In this case, after generating the target media stream data, the push node may send the target media stream data to the origin station of the content delivery network for storage. Subsequently, the protocol conversion device may acquire the target media stream data from the data origin station of the content delivery network. In another example embodiment, the second device may be an edge node in the content delivery network. In yet another example embodiment, the second device may be a device outside the content delivery network, such as the pull device 140 shown in FIG. 1.

It may be seen that as compared with the existing solution in which the protocol conversion is performed at the central origin station and the converted data files are distributed to the edge nodes, the method for data processing according to the embodiments of the present disclosure may support transparent transmission in the stream transmission system using the FLV or RTMP protocol, and the same FLV or RTMP protocol is used for the edge nodes to acquire data from an origin. This may not only make the encapsulation less redundant, but also omit frequent interactive requests when the edge nodes acquire data from the origin, thereby saving network bandwidth. In addition, the method for data processing according to the embodiments of the present disclosure may achieve distributed consistent segmentation without relying on external network services, thereby saving costs.

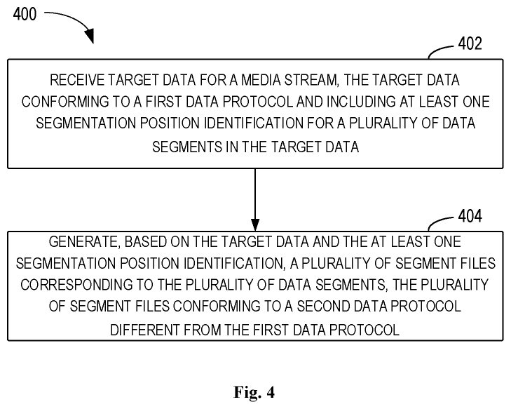

FIG. 4 illustrates a flowchart of a method 400 for protocol conversion according to some embodiments of the present disclosure. In some embodiments, the method 400 may be performed at the transmission device 132 as shown in FIG. 1. It should be understood that the method 400 may further include additional blocks not shown and/or may omit a certain block (or some blocks) shown, and the scope of the present disclosure is not limited in this regard.

At block 402, target data for a media stream is received. The target data conforms to a first data protocol and includes at least one segmentation position identification for a plurality of data segments in the target data. The target data may be generated according to the method for data processing described in conjunction with FIG. 2 to FIG. 3, and has been described in detail above. Therefore, the concepts of the target data, the first data protocol, the segmentation position identification, etc. are not repeated in the present disclosure.

At block 404, a plurality of segment files corresponding to the plurality of data segments are generated based on the target data and the at least one segmentation position identification. The plurality of segment files conform to a second data protocol different from the first data protocol. The second data protocol may be a data transmission protocol to which the original media stream data needs to be converted, that is, a target data transmission protocol for the protocol conversion. For example, the second data protocol may be a segment-based streaming protocol, such as a DASH protocol, an HLS protocol, and so on. For example, the original media stream data may be converted from the first data protocol to the DASH protocol or the HLS protocol.

In some embodiments, the segmentation position identification added to the target media stream data may be identified. The segmentation position identification at least indicates a segmentation position when the first data protocol is converted to the second data protocol. For example, after the target media stream data is acquired, the segmentation position identification added to the target media stream data may be identified, for example, a data frame or a data message included in the target media stream data and used to indicate the segmentation position may be identified.

Further, the protocol conversion may be performed on the target media stream data based on the segmentation position indicated by the segmentation position identification. In some embodiments, the segmentation position for segmenting the target media stream data may be extracted from the segmentation position identification. Alternatively, a position of the segmentation position identification in the target media stream data may be determined as the segmentation position indicated by the segmentation position identification. Then, the target media stream data may be segmented based on the determined segmentation position to obtain the data file that conforms to the second data protocol. For example, a plurality of data segments may be extracted from the target media stream data based on the segmentation position, and these data segments may be repackaged to obtain a plurality of segment files that conform to the second data protocol. Since the segmentation position in the method according to the embodiments of the present disclosure is a position for protocol conversion, and the segmentation position identification may be used to implement the protocol conversion, the segmentation position may also be referred to as a protocol conversion position, and the segmentation position identification may also be referred to as a protocol conversion position.

In some embodiments, the segment file may be in MPEG-2 Transport Stream (TS) format, Fragmented MP4 (FMP4) format, or Common Media Application Format (CMAF), and so on. The segment file may include a video file and/or an audio file. For example, after the segmentation position is determined, the target media stream data may be segmented, and the data file that conforms to the second data protocol may be generated based on a media stream data segment obtained through segmentation. For example, a video segment file that conforms to the second data protocol is generated based on a video frame (such as a video key frame and a video forward reference frame) included in the media stream data segment obtained through segmentation, and an audio segment file that conforms to the second data protocol is generated based on an audio frame included in the media stream data segment obtained through segmentation.

In some embodiments, the segmentation position identification includes current description information for the second data protocol of the plurality of media segments. In this case, the current description information contained in the segmentation position identification may also be acquired, and the description file for the second data protocol may be updated according to the current description information. Additionally, the target media stream data may be segmented based on the segmentation position and the updated description file. For example, the segmentation position identification added at each segmentation position may contain the current description information (for example, the latest description information) for the second data protocol of one or more media segments before and after the segmentation position. Further, the description file corresponding to the second data protocol when the target media stream data is converted from the first data protocol to the second data protocol may be updated according to the current description information. The corresponding segment file may be restored from the data segment based on the segmentation position and the information (for example, the time stamp start position, the URL, etc.) carried by the updated description file, thereby implementing the protocol conversion of the target media stream data.

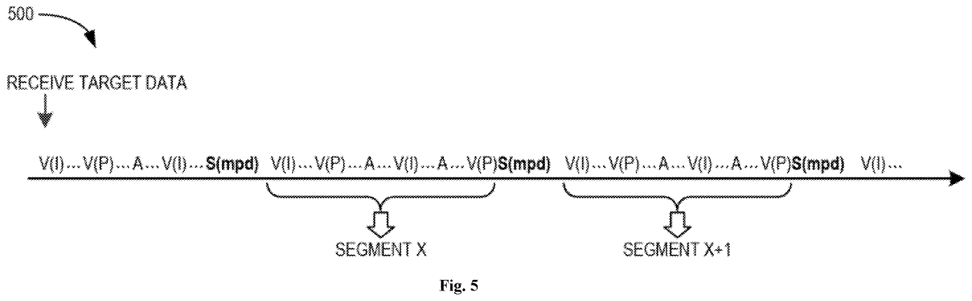

FIG. 5 illustrates a schematic diagram 500 of segmentation processing for target media stream data according to some embodiments of the present disclosure. As shown in FIG. 5, after the target media stream data is received, the rule for inserting these Script frames is inferred reversely. S (mpd) represents a Script frame containing MPD information, which indicates a boundary between data segments. In other words, a media stream data segment between two adjacent Script frames may be repackaged into one segment file. Based on the media stream data segment, a segment X (such as a video segment x and an audio segment x′) may be generated according to the MPD information (for example, a time stamp start position and a URL of the segment file) carried in the Script frame, and a segment X+1 (such as a video segment x+1 and an audio segment x+1′) may also be generated after a period of time, thereby implementing the conversion from the FLV protocol to the DASH protocol. It should be understood that the Script frame containing the MPD information shown in FIG. 5 is only illustrative, and in some other embodiments, the Script frame may also include any other suitable information, such as m3u8 information, and so on. The scope of the present disclosure is not limited in this regard.

It may be seen from the above description with reference to FIGS. 4 to 5 that in the method for protocol conversion according to the embodiments of the present disclosure, the segment file is generated from the target data based on the segmentation position identification carried in the target media stream data, so as to implement the conversion from the first data protocol to the second data protocol. In this way, it may be achieved that the protocol conversion results of the same media stream data by different protocol conversion devices are consistent, thereby ensuring the distributed consistency of segmentation. Therefore, this makes it possible to support protocol conversion for the same media stream on different protocol conversion devices, and ensure that when the protocol conversion devices are switched, a player will not have a playback error due to inconsistent segmentation results, so that the efficiency and fault-tolerance of the protocol conversion may be improved, and the playback effect of the media stream data may be improved.

In some embodiments, the method for protocol conversion according to the embodiments of the present disclosure may be implemented at a third device in the stream transmission system 130 for the media stream. For example, the third device may be the same device as the second device described above. Alternatively, the third device may be different from the second device, but is communicatively coupled to the second device. The scope of the present disclosure is not limited in this regard.

The third device may receive a request for the media stream from a fourth device. Further, the third device may determine, based on the request, whether the fourth device is also located in the stream transmission system 130. For example, the third device may determine whether the fourth device is located in the stream transmission system 130 based on a parameter or an attribute of the request. Alternatively, the request itself from the fourth device may carry information indicating whether the fourth device is located in the stream transmission system 130. Additionally, the third device may determine which protocol is applied for data transmission between the third device and the fourth device.

If it is determined that the fourth device is in the stream transmission system 130, the target data is sent to the fourth device. In this way, the target media stream data carrying the segmentation position information may be transmitted transparently in the stream transmission system. If it is determined that the fourth device is outside the stream transmission system 130 and the second data protocol is applied, the third device sends the segment file to the fourth device. Additionally, the third device may further send the description information for the second data protocol extracted from the segmentation position identification to the fourth device, such as an MPD file for the DASH protocol or an m3u8 file for the HLS protocol. If it is determined that the fourth device is outside the stream transmission system 130 and the first data protocol is applied, the third device may obtain the original data for the media stream by deleting all the segmentation position identifications from the target data, and send the original data to the fourth device. In this way, on the one hand, it is possible to avoid errors when a device outside the stream transmission system parses or plays the target media stream data; on the other hand, in the case where some services need to distribute both media stream data conforming to the first data protocol and media stream data conforming to the second data protocol at the same time, the solution of the embodiments of the present disclosure only needs one origin-pull path for the media stream data conforming to the first data protocol, and then the media stream data conforming to the second data protocol may be generated through protocol conversion, which may effectively save origin-pull bandwidth cost.

In some embodiments, in a case where the stream transmission system 130 is implemented through a content delivery network, the third device may be an edge node in the content delivery network. For example, the third device may be an edge node in the content delivery network that serves the pull device 140. In an example embodiment, the fourth device may be an edge node in the content delivery network. In another example embodiment, the fourth device may be a device outside the content delivery network, such as the pull device 140 shown in FIG. 1. In this case, as compared with the existing solution in which the protocol conversion is performed at the central origin station and the edge nodes acquire data from an origin, the method according to the embodiments of the present disclosure performs the protocol conversion at the edge node, and when the pull device requests the segment file, the segment file already exists at the edge node and may be directly responded to. This greatly reduces resource response latency, thereby optimizing the playback response speed of the media stream data.

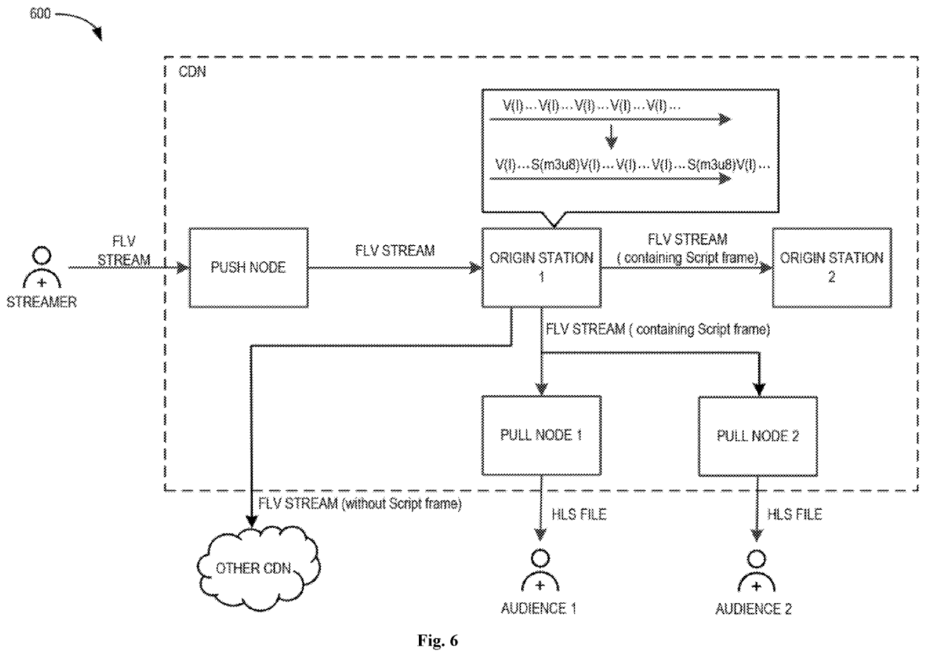

FIG. 6 illustrates a schematic diagram 600 of an example media stream distribution process according to some embodiments of the present disclosure. In the example of FIG. 6, the first data protocol is the FLV protocol, the second data protocol is the HLS protocol, and the protocol conversion device is an origin station 1. The live streaming side uploads original media stream data that conforms to the FLV protocol. The protocol conversion process is simulated at the first upstream origin station (that is, the origin station 1), but no actual file is generated. After the m3u8 file is updated, the m3u8 information (that is, the current description information) is written into the FLV stream as a segmentation position identification in the form of a Script frame, thereby obtaining the FLV stream (that is, the target media stream data) containing the Script frame. The m3u8 information is transmitted transparently in the CDN system with the Script frame. A pull node 1 acquires the FLV stream containing the Script frame from the origin station 1 by acquiring data from an origin. The pull node 1 restores HLS files, such as an m3u8 file and a segment file, according to the m3u8 information in the Script frame. Further, the pull node 1 sends the HLS files to the client of audience 1. Similarly, a pull node 2 acquires the FLV stream containing the Script frame from the origin station 1 by acquiring data from an origin. The pull node 2 restores HLS files, such as an m3u8 file and a segment file, according to the m3u8 information in the Script frame. Further, the pull node 2 sends the HLS files to the client of audience 2. Here, the pull node 1 and the pull node 2 may generate consistent HLS files, thus achieving the distributed consistency of segmentation.

In addition, when the FLV stream is distributed externally, the Script frame carrying the m3u8 information in the FLV stream may be deleted. For example, during internal cascading, it may be identified through the request parameter whether the peer end is another streaming media server inside the system or an external device, and if it is an external device, the custom tag information (that is, the Script frame) is deleted. In the example of FIG. 6, after the Script frame is deleted, the pull node 1 and/or the pull node 2 may send the FLV stream that does not contain the Script frame to an external device, which is not shown in FIG. 6. In addition, the origin station 1 may also send the FLV stream that does not contain the Script frame to other CDNs.

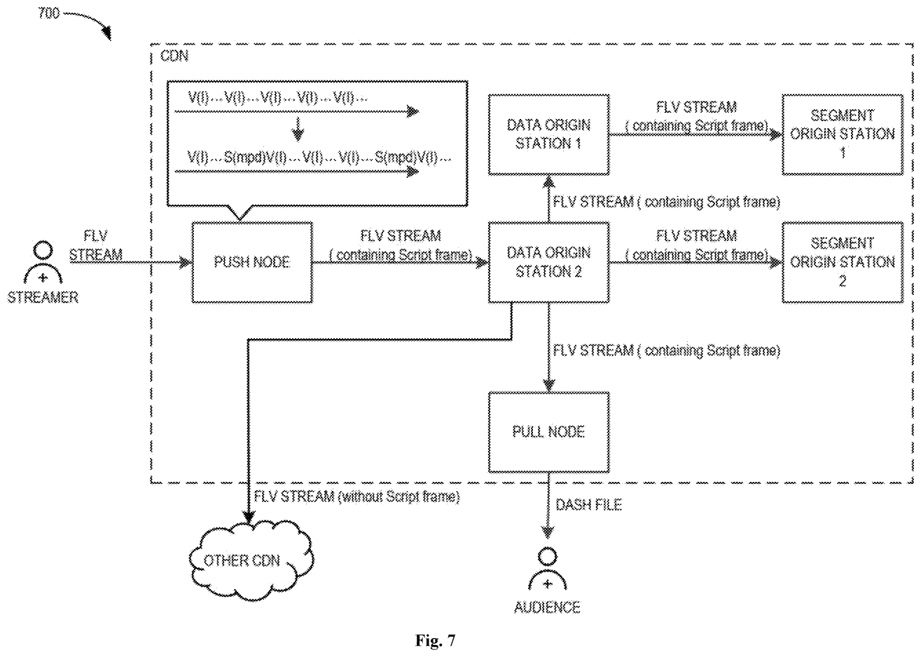

FIG. 7 illustrates a schematic diagram 700 of another example media stream distribution process according to some embodiments of the present disclosure. In the example of FIG. 7, the first data protocol is the FLV protocol, the second data protocol is the DASH protocol, and the protocol conversion device is a push node. The live streaming side uploads original media stream data that conforms to the FLV protocol. The protocol conversion process is simulated at the first upstream streaming media server (that is, the push node), but no actual file is generated. After the MPD file is updated, the MPD information (that is, the current description information) is written into the FLV stream as a segmentation position identification in the form of a Script frame, thereby obtaining the FLV stream (that is, the target media stream data) containing the Script frame. The MPD information is transmitted transparently in the CDN system with the Script frame. The pull node acquires the FLV stream containing the Script frame from a data origin station 2 by acquiring data from an origin. The DASH files, such as the MPD file and the segment file, are restored according to the MPD information in the Script frame. Further, the pull node sends the DASH files to the client of the audience.

In addition, when the FLV stream is distributed externally, the Script frame carrying the MPD information in the FLV stream may be deleted. For example, during internal cascading, it may be identified through the request parameter whether the peer end is another streaming media server inside the system or an external device, and if it is an external device, the custom tag information (that is, the Script frame) is deleted. In the example of FIG. 7, the origin station 1 may send the FLV stream that does not contain the Script frame to other CDNs.

In the example shown in FIG. 7, the protocol conversion device (that is, the device that performs the protocol conversion in the CDN) may include a protocol conversion origin station or an edge node in the CDN. When the protocol conversion is performed by means of central slicing, the protocol conversion device may include an origin station in the CDN, such as a segment origin station 1, a segment origin station 2, and so on. When the protocol conversion is performed by means of edge slicing, the protocol conversion device includes an edge node in the CDN, such as the pull node, and so on.

In the examples of FIGS. 6 and 7, the cascading protocol (that is, the transmission protocol between the pull node and the upstream node or the origin station) is the FLV protocol. In this case, the segmentation position identification may be implemented in a form of a custom Script frame, and the manifest information (for example, an MPD or m3u8 file) is encapsulated in the Script frame. In some other embodiments, the RTMP protocol is used as the cascading protocol. In this case, the MPD information may be transmitted through a metadata message using an AMFO package. At this time, the protocol conversion identification may be added to the original media stream data in the form of the metadata message. It should be understood that the solution according to the embodiments of the present disclosure also supports any other suitable cascading protocol, and the scope of the present disclosure is not limited in this regard.

It may be seen that by inserting the segmentation-related information (such as the protocol conversion identification) into the media stream data and passing the segmentation-related information to each of the streaming media servers in the system with the transmission of the media stream data, these streaming media servers are enabled to generate consistent segment files according to the media stream data and the segmentation information carried by the media stream data, thereby achieving the purpose of distributed consistent segmentation. In this way, the distributed consistent segmentation may be efficiently implemented by only using the stream transmission between the streaming media servers without relying on external services, thereby solving the problem of poor flexibility and availability of the existing solution that fixes the segmentation task on a single segmentation device.

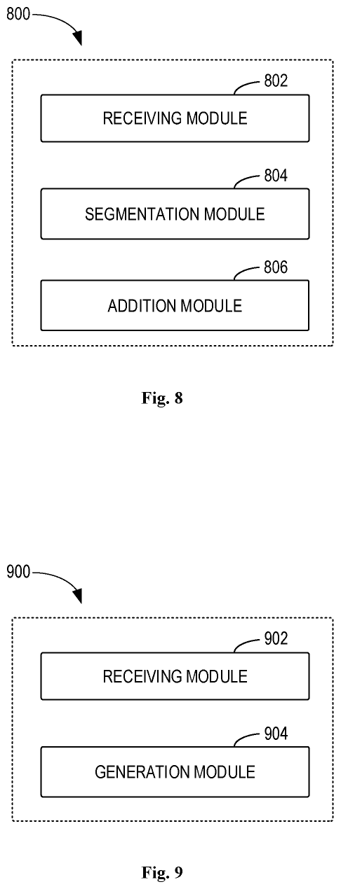

The embodiments of the present disclosure further provide corresponding apparatuses and devices for implementing the above methods or processes. FIG. 8 illustrates a block diagram of an example apparatus 800 for data processing according to some embodiments of the present disclosure. The apparatus 800 may be used, for example, to implement the method for data processing according to some embodiments of the present disclosure. In some embodiments, the apparatus 800 may be implemented at the push device 120 or the transmission device 132 shown in FIG. 1.

As shown in FIG. 8, the apparatus 800 may include a receiving module 802, a segmentation module 804, and an addition module 806. The receiving module 802 is configured to receive original data for a media stream. The segmentation module 804 is configured to segment the original data into a plurality of data segments. The addition module 806 is configured to add at least one segmentation position identification for the plurality of data segments to the original data to obtain target data for the media stream. The target data conforms to a same first data protocol as the original data.

In some embodiments, each of the at least one segmentation position identification corresponds to two adjacent data segments of the plurality of data segments, and indicates a position of a boundary between the two adjacent data segments.

In some embodiments, each of the at least one segmentation position identification is inserted between the two corresponding adjacent data segments.

In some embodiments, the at least one segmentation position identification includes description information of a plurality of media segments of the media stream that correspond to the plurality of data segments, the description information being used for a second data protocol different from the first data protocol.

In some embodiments, the at least one segmentation position identification further includes an identification for a method.

In some embodiments, if it is determined that the second data protocol includes an HTTP Live Streaming (HLS) protocol, the description information includes index information for the HLS protocol of the plurality of media segments, or if it is determined that the second data protocol includes a Dynamic Adaptive Streaming over HTTP (DASH) protocol, the description information includes a Media Presentation Description (MPD) for the DASH protocol of the plurality of media segments.

In some embodiments, the description information includes description information corresponding to each track of at least one track of the media stream, and the target data includes a mapping relationship between each track and the corresponding description information.

In some embodiments, if it is determined that the second data protocol includes an HLS protocol, the segmentation position identification includes a first indication for indicating a mapping relationship between a track index and index information for the HLS protocol of the plurality of media segments, and the target data includes a second indication for indicating an HLS multivariant playlist, and a third indication for indicating a mapping between a track index and an HLS variant stream, or if it is determined that the second data protocol includes a DASH protocol, the segmentation position identification includes an MPD for the DASH protocol of the plurality of media segments, and the target data includes a fourth indication for indicating a mapping between a track index and a DASH representation.

In some embodiments, information included in the at least one segmentation position identification is encapsulated based on a target data structure, and the target data structure depends on the first data protocol.

In some embodiments, if it is determined that the first data protocol includes a Flash Video (FLV) protocol, the target data structure includes a script data (SCRIPTDATA) structure, or if it is determined that the first data protocol includes a Real Time Messaging Protocol (RTMP), the target data structure corresponds to a metadata message.

In some embodiments, the at least one segmentation position identification is unencrypted.

In some embodiments, the original data is segmented based on at least one of: a predetermined duration of a data segment, or a position of a random access point in the media stream.

In some embodiments, the apparatus 800 is implemented at a first device in a stream transmission system for the media stream. The apparatus 800 further includes a request receiving module and a sending module. The request receiving module is configured to receive a request for the media stream from a second device. The sending module is configured to: if it is determined that the second device is in the stream transmission system, send the target data for the media stream to the second device, or if it is determined that the second device is outside the stream transmission system, send the original data for the media stream to the second device.

In some embodiments, the stream transmission system is implemented through a content delivery network, and the first device includes an origin station or an edge node in the content delivery network, and/or the second device includes an origin station or an edge node in the content delivery network, or a device outside the content delivery network.

FIG. 9 illustrates a block diagram of an example apparatus 900 for protocol conversion according to some embodiments of the present disclosure. The apparatus 900 may be used, for example, to implement the method for protocol conversion according to some embodiments of the present disclosure. In some embodiments, the apparatus 900 may be implemented at the transmission device 132 shown in FIG. 1.

As shown in FIG. 9, the apparatus 900 may include a receiving module 902 and a generation module 904. The receiving module 902 is configured to receive target data for a media stream. The target data conforms to a first data protocol and includes at least one segmentation position identification for a plurality of data segments in the target data. The generation module 904 is configured to: generate, based on the target data and the at least one segmentation position identification, a plurality of segment files corresponding to the plurality of data segments, the plurality of segment files conforming to a second data protocol different from the first data protocol.

In some embodiments, each of the at least one segmentation position identification corresponds to two adjacent data segments of the plurality of data segments, and indicates a position of a boundary between the two adjacent data segments.

In some embodiments, each of the at least one segmentation position identification is inserted between the two corresponding adjacent data segments.

In some embodiments, the at least one segmentation position identification includes description information of a plurality of media segments of the media stream that correspond to the plurality of data segments, the description information being used for the second data protocol.

In some embodiments, the at least one segmentation position identification further includes an identification for a method.

In some embodiments, if it is determined that the second data protocol includes an HLS protocol, the description information includes index information for the HLS protocol of the plurality of media segments, or if it is determined that the second data protocol includes a DASH protocol, the description information includes an MPD for the DASH protocol of the plurality of media segments.

In some embodiments, the description information includes description information corresponding to each track of at least one track of the media stream, and the target data includes a mapping relationship between each track and the corresponding description information.

In some embodiments, if it is determined that the second data protocol includes an HLS protocol, the segmentation position identification includes a first indication for indicating a mapping relationship between a track index and index information for the HLS protocol of the plurality of media segments, and the target data includes a second indication for indicating an HLS multivariant playlist, and a third indication for indicating a mapping between a track index and an HLS variant stream, or if it is determined that the second data protocol includes a DASH protocol, the segmentation position identification includes an MPD for the DASH protocol of the plurality of media segments, and the target data includes a fourth indication for indicating a mapping between a track index and a DASH representation.

In some embodiments, information included in the at least one segmentation position identification is encapsulated based on a target data structure, and the target data structure depends on the first data protocol.

In some embodiments, if it is determined that the first data protocol includes an FLV protocol, the target data structure includes a SCRIPTDATA structure, or if it is determined that the first data protocol includes RTMP, the target data structure corresponds to a metadata message.

In some embodiments, the at least one segmentation position identification is unencrypted.

In some embodiments, the generation module 904 is further configured to: extract the plurality of data segments from the target data based on the at least one segmentation position identification; and repackage the plurality of data segments to obtain the plurality of segment files.

In some embodiments, the apparatus 900 is implemented at a third device in a stream transmission system for the media stream. The apparatus 900 further includes a request receiving module and a sending module. The request receiving module is configured to receive a request for the media stream from a fourth device. The sending module is configured to: if it is determined that the fourth device is outside the stream transmission system and the second data protocol is applied, send the segment file to the fourth device, or if it is determined that the fourth device is outside the stream transmission system and the first data protocol is applied, obtain the original data for the media stream by deleting all the segmentation position identifications from the target data, and send the original data to the fourth device, or if it is determined that the fourth device is in the stream transmission system, send the target data to the fourth device.

In some embodiments, the stream transmission system is implemented through a content delivery network, and the third device includes an edge node in the content delivery network, and/or the fourth device includes an edge node in the content delivery network, or a device outside the content delivery network.

The modules and/or units included in the apparatus 800 and the apparatus 900 may be implemented in various ways, including software, hardware, firmware, or any combination thereof. In some embodiments, one or more units may be implemented using software and/or firmware, for example machine executable instructions stored on a storage medium. In addition to machine executable instructions or as an alternative, some or all units in the apparatus 800 and the apparatus 900 may be implemented at least partially by one or more hardware logic components. As an example, rather than a limitation, example types of hardware logic components that may be used include field programmable gate arrays (FPGAs), application specific integrated circuits (ASICs), application specific standards (ASSPs), system-on-chips (SOCs), complex programmable logic devices (CPLDs), and so on.

These modules and/or units shown in FIGS. 8 and 9 may be partially or entirely implemented as a hardware module, a software module, a firmware module, or any combination thereof. In particular, in certain embodiments, the processes, methods, or procedures described above may be implemented by hardware in a storage system or a host computer corresponding to the storage system or other computing devices independent of the storage system.

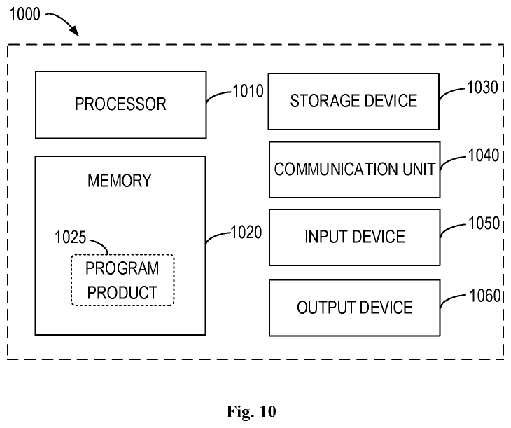

FIG. 10 illustrates a block diagram of a device 1000 in which one or more embodiments of the present disclosure may be implemented. It should be understood that the electronic device 1000 shown in FIG. 10 is only illustrative and should not constitute any limitation to the function and scope of the embodiments described herein. The electronic device 1000 shown in FIG. 10 may be used to implement the push device 120, the transmission device 132 shown in FIG. 1, and/or the methods described above.

As shown in FIG. 10, the electronic device 1000 is in a form of a general-purpose electronic device. The components of the electronic device 1000 may include, but are not limited to, one or more processing units or processors 1010, a memory 1020, a storage device 1030, one or more communication units 1040, one or more input devices 1050, and one or more output devices 1060. The processor 1010 may be an actual or virtual processor and may perform various processes based on programs stored in the memory 1020. In a multi-processor system, multiple processing units execute computer executable instructions in parallel to improve the parallel processing capability of the electronic device 1000.

The electronic device 1000 typically includes multiple computer storage media. Such media may be any available media accessible to the electronic device 1000, including, but not limited to, volatile and non-volatile media, removable and non-removable media. The memory 1020 may be a volatile memory (for example, a register, cache, a random access memory (RAM)), a non-volatile memory (such as a read-only memory (ROM), an electrically erasable programmable read-only memory (EEPROM), a flash memory), or any combination thereof. The storage device 1030 may be any removable or non-removable medium, and may include a machine-readable medium such as a flash drive, a disk, or any other medium, which may be used to store information and/or data (such as training data for training) and may be accessed within the electronic device 1000.

The electronic device 1000 may further include additional removable/non-removable, volatile/non-volatile storage media. Although not shown in FIG. 10, a disk driver for reading from or writing to a removable, non-volatile disk (such as a “floppy disk”), and an optical disk driver for reading from or writing to a removable, non-volatile optical disk may be provided. In these cases, each driver may be connected to a bus (not shown) by one or more data medium interfaces. The memory 1020 may include a computer program product 1025, which has one or more program modules configured to perform various methods or acts of various implementations of the present disclosure.

The communication unit 1040 implements communication with other electronic devices through a communication medium. Additionally, the functions of the components of the electronic device 1000 may be implemented by a single computing cluster or multiple computing machines, which may communicate through communication connections. Therefore, the electronic device 1000 may use a logical connection with one or more other servers, a network personal computer (PC) or another network node to operate in a networked environment.

The input device 1050 may be one or more input devices, such as a mouse, a keyboard, a tracking ball, etc. The output device 1060 may be one or more output devices, such as a display, a speaker, a printer, etc. The electronic device 1000 may also communicate, as needed, via the communication unit 1040, with one or more external devices (not shown), such as a storage device, a display device, etc.; with one or more devices that enable a user to interact with the electronic device 1000; or with any devices (such as a network card, a modem, etc.) that enable the electronic device 1000 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, which are executed by a processor to implement the method described above. According to an example implementation of the present disclosure, there is provided a computer program product having a computer program stored thereon, where the program implements the method described above when executed by a processor.

Aspects of the present disclosure are described herein with reference to flowcharts and/or block diagrams of methods, apparatuses, devices and computer program products implemented according to the present disclosure. It should be understood that each block of the flowchart and/or block diagram, and combinations of blocks in the flowchart and/or block diagram, may be implemented by computer-readable program instructions.

These computer-readable program instructions may be provided to a processor of a general-purpose computer, a special-purpose computer, or other programmable data processing apparatus to produce a machine, such that the instructions, when executed by the processor of the computer or other programmable data processing apparatus, produce an apparatus that implements functions/actions specified in one or more blocks of the flowchart and/or block diagram. These computer-readable program instructions may also be stored in a computer-readable storage medium, which instructions cause a computer, a programmable data processing apparatus, and/or other devices to work in a particular manner, so that the computer-readable medium storing the instructions includes an article of manufacture including instructions that implement various aspects of the functions/actions specified in one or more blocks of the flowchart and/or block diagram.

The computer-readable program instructions may be loaded onto a computer, another programmable data processing apparatus, or other devices to cause a series of operating steps to be performed on the computer, the other programmable data processing apparatus, or the other devices to produce a computer-implemented process, such that the instructions executed on the computer, the other programmable data processing apparatus, or the other devices implement the functions/actions specified in one or more blocks of the flowchart and/or block diagram.

The flowchart and block diagrams in the drawings show the possibly implemented architectures, functions, and operations of the system, the method, and the computer program product according to multiple implementations of the present disclosure. In this regard, each block in the flowchart or block diagram may represent a module, a program segment, or a portion of instructions, which contains one or more executable instructions for implementing specified logical functions. In some alternative implementations, functions marked in the blocks may also occur in an order different from that marked in the drawings. For example, two consecutive blocks may actually be performed substantially in parallel, or they may sometimes be performed in a reverse order, depending on the functions involved. It should also be noted that each block of the block diagram and/or flowchart, and a combination of blocks in the block diagram and/or flowchart may be implemented in a special-purpose hardware-based system that performs specified functions or actions, or may be implemented in a combination of special-purpose hardware and computer instructions.

The implementations of the present disclosure have been described above. The above description is illustrative, non-exhaustive, and is not limited to the disclosed implementations. Many modifications and variations will be apparent to those of ordinary skill in the art without departing from the scope and spirit of the illustrated implementations. The terms used herein are chosen to best explain the principles of the implementations, the practical applications or improvements to the technology in the market, or to enable other persons of ordinary skill in the art to understand the implementations disclosed herein.

1. A method for data processing, comprising:
receiving original data for a media stream;
segmenting the original data into a plurality of data segments; and
adding at least one segmentation position identification for the plurality of data segments to the original data to obtain target data for the media stream, the target data conforming to a same first data protocol as the original data.

2. The method of claim 1, wherein each of the at least one segmentation position identification corresponds to two adjacent data segments of the plurality of data segments, and indicates a position of a boundary between the two adjacent data segments, and
wherein each of the at least one segmentation position identification is inserted between the two corresponding adjacent data segments.

3. The method of claim 1, wherein the at least one segmentation position identification comprises description information of a plurality of media segments of the media stream that correspond to the plurality of data segments, the description information being used for a second data protocol different from the first data protocol.

4. The method of claim 3, wherein the at least one segmentation position identification further comprises an identification for the method, or
wherein in response to determining that the second data protocol comprises a hypertext transfer protocol (HTTP) live streaming (HLS) protocol, the description information comprises index information for the HLS protocol of the plurality of media segments, or in response to determining that the second data protocol comprises a dynamic adaptive streaming over HTTP (DASH) protocol, the description information comprises a media presentation description (MPD) for the DASH protocol of the plurality of media segments.

5. The method of claim 3, wherein the description information comprises description information corresponding to each track of at least one track of the media stream, and the target data comprises a mapping relationship between the each track and the corresponding description information.

6. The method of claim 5, wherein in response to determining that the second data protocol comprises an HLS protocol, the segmentation position identification comprises a first indication for indicating a mapping relationship between a track index and index information for the HLS protocol of the plurality of media segments, and the target data comprises a second indication for indicating an HLS multivariant playlist, and a third indication for indicating a mapping between a track index and an HLS variant stream, or
in response to determining that the second data protocol comprises a DASH protocol, the segmentation position identification comprises an MPD for the DASH protocol of the plurality of media segments, and the target data comprises a fourth indication for indicating a mapping between a track index and a DASH representation.

7. The method of claim 3, wherein information comprised in the at least one segmentation position identification is encapsulated based on a target data structure, and the target data structure depends on the first data protocol.

8. The method of claim 7, wherein in response to determining that the first data protocol comprises a flash video (FLV) protocol, the target data structure comprises a script data (SCRIPTDATA) structure, or
in response to determining that the first data protocol comprises a real time messaging protocol (RTMP), the target data structure corresponds to a metadata message.

9. The method of claim 1, wherein the at least one segmentation position identification is unencrypted, or
wherein the original data is segmented based on at least one of: a predetermined duration of a data segment, or a position of a random access point in the media stream, or
wherein the method is implemented at a first device in a stream transmission system for the media stream, and the method further comprises:
receiving a request for the media stream from a second device; and
in response to determining that the second device is in the stream transmission system, sending the target data for the media stream to the second device, or
in response to determining that the second device is outside the stream transmission system, sending the original data for the media stream to the second device.

10. A method for protocol conversion, comprising:
receiving target data for a media stream, the target data conforming to a first data protocol and comprising at least one segmentation position identification for a plurality of data segments in the target data; and
generating, based on the target data and the at least one segmentation position identification, a plurality of segment files corresponding to the plurality of data segments, the plurality of segment files conforming to a second data protocol different from the first data protocol.

11. The method of claim 10, wherein each of the at least one segmentation position identification corresponds to two adjacent data segments of the plurality of data segments, and indicates a position of a boundary between the two adjacent data segments, and
wherein each of the at least one segmentation position identification is inserted between the two corresponding adjacent data segments.

12. The method of claim 10, wherein the at least one segmentation position identification comprises description information of a plurality of media segments of the media stream that correspond to the plurality of data segments, the description information being used for the second data protocol.

13. The method of claim 12, wherein the at least one segmentation position identification further comprises an identification for the method.

14. The method of claim 12, wherein in response to determining that the second data protocol comprises an HLS protocol, the description information comprises index information for the HLS protocol of the plurality of media segments, or
in response to determining that the second data protocol comprises a DASH protocol, the description information comprises an MPD for the DASH protocol of the plurality of media segments.

15. The method of claim 12, wherein the description information comprises description information corresponding to each of at least one track of the media stream, and the target data comprises a mapping relationship between each track and the corresponding description information.

16. The method of claim 15, wherein in response to determining that the second data protocol comprises an HLS protocol, the segmentation position identification comprises a first indication for indicating a mapping relationship between a track index and index information for the HLS protocol of the plurality of media segments, and the target data comprises a second indication for indicating an HLS multivariant playlist, and a third indication for indicating a mapping between a track index and an HLS variant stream, or
in response to determining that the second data protocol comprises a DASH protocol, the segmentation position identification comprises an MPD for the DASH protocol of the plurality of media segments, and the target data comprises a fourth indication for indicating a mapping between a track index and a DASH representation.

17. The method of claim 12, wherein information comprised in the at least one segmentation position identification is encapsulated based on a target data structure, and the target data structure depends on the first data protocol.

18. The method of claim 17, wherein in response to determining that the first data protocol comprises a FLV protocol, the target data structure comprises a SCRIPTDATA structure, or
in response to determining that the first data protocol comprises an RTMP, the target data structure corresponds to a metadata message.

19. The method of claim 10, wherein the at least one segmentation position identification is unencrypted, or
wherein generating the plurality of segment files comprises: extracting the plurality of data segments from the target data based on the at least one segmentation position identification; and repackaging the plurality of data segments to obtain the plurality of segment files, or
wherein the method is implemented at a third device in a stream transmission system for the media stream, and the method further comprises:
receiving a request for the media stream from a fourth device; and
in response to determining that the fourth device is outside the stream transmission system and the second data protocol is applied, sending the segment file to the fourth device, or
in response to determining that the fourth device is outside the stream transmission system and the first data protocol is applied, obtaining original data for the media stream by deleting all the segmentation position identifications from the target data, and sending the original data to the fourth device, or in response to determining that the fourth device is in the stream transmission system, sending the target data to the fourth device.

20. An apparatus for data processing, comprising:
a receiving module configured to receive original data for a media stream;
a segmentation module configured to segment the original data into a plurality of data segments; and
an addition module configured to add at least one segmentation position identification for the plurality of data segments to the original data to obtain target data for the media stream, the target data conforming to a same first data protocol as the original data.
